(19) United States
(12) Patent Application Publication
(10) Pub. No.: US 2009/0303627 A1
(43) Pub. Date: Dec. 10, 2009

(54) MAGNETIC TRANSFER MASTER CARRIER, MAGNETIC TRANSFER METHOD, AND MAGNETIC RECORDING MEDIUM

(75) Inventors: Yoichi NISHIDA, Odawara-shi (JP); Hideyuki Kubota, Odawara-shi (JP); Masakazu Nishikawa, Odawara-shi (JP); Makoto Nagao, Odawara-shi (JP); Ryuji Sugita, Hitachi-shi (JP); Takashi Komine, Hitachi-shi (JP)

Correspondence Address: YOUNG & THOMPSON, 209 Madison Street, Suite 500, ALEXANDRIA, VA, 22314, US

(73) Assignee: FUJIFILM Corporation, Tokyo (JP)

(21) Appl. No.: 12/477,350

(22) Filed: Jun. 3, 2009

(30) Foreign Application Priority Data
Jun. 6, 2008 (JP) 2008-149540

(51) Int. Cl. G11B 5/86

(52) U.S. Cl. 360/17; G9B/5.308

(57) ABSTRACT

A magnetic transfer master carrier including a base material having, in its surface, convex portions arranged correspondingly to a pattern of information to be recorded on a perpendicular magnetic recording medium, and a magnetic layer having perpendicular magnetic anisotropy, the layer being provided on top and side surfaces of the convex portions, wherein the magnetic transfer master carrier forms a magnetic field pattern corresponding to the pattern of the information when a magnetic field is applied thereto.

### BACKGROUND OF THE INVENTION

1. Field of the Invention

The present invention relates to a magnetic transfer master carrier used for magnetically transferring information onto a magnetic recording medium; a magnetic transfer method using the magnetic transfer master carrier; and a magnetic recording medium produced by the magnetic transfer method.

2. Description of the Related Art

As a magnetic recording medium attaining high density information recording, there is known a magnetic recording medium employing perpendicular magnetic recording (hereinafter referred to as a “perpendicular magnetic recording medium”). The perpendicular magnetic recording medium has an information recording area composed of narrow tracks. Thus, a tracking servo technology for accurately scanning with a magnetic head within a narrow track width and for recording/reproducing a signal with a high S/N ratio is important to the perpendicular magnetic recording medium. In order to perform this tracking servo, servo information such as a servo signal for tracking, an address information signal and a reproduction clock signal needs to be recorded at predetermined intervals on the perpendicular magnetic recording medium as a so-called preformat.

In one method for preformatting servo information on a perpendicular magnetic recording medium, a master carrier having a pattern composed of a plurality of convex portions on which surfaces magnetic layers are laid, the pattern corresponding to the servo information, is closely attached to the perpendicular magnetic recording medium; and, in this state, a recording magnetic field is applied to magnetically transfer, onto the perpendicular magnetic recording medium, the servo information corresponding to the pattern of the master carrier (see, for example, Japanese Patent Application Laid-Open (JP-A) Nos. 2003-203325 and 2000-195048, and U.S. Pat. No. 7,218,465).

In this method, when the recording magnetic field is applied to the perpendicular magnetic recording medium and the master carrier that have been closely attached to each other, the patternwise arranged magnetic layers absorb magnetic flux from the master carrier. As a result, the recording magnetic field is increased in response to the pattern of the master carrier. The patternwise increased magnetic field inverts the magnetization at only predetermined portions of the perpendicular magnetic recording medium. In this manner, the servo information corresponding to the pattern of the master carrier is magnetically transferred onto the perpendicular magnetic recording medium.

After magnetic transfer, application of the recording magnetic field is terminated, and the master carrier is separated from the perpendicular magnetic recording medium, which has been closely attached thereto.

Conventionally, the magnetic layer of the master carrier has been made of an isotropic magnetic material having high saturation magnetization. This is because the magnetization of the magnetic layer of the master carrier is increased upon application of a recording magnetic field to render the magnetic layer to easily absorb magnetic flux.

Also, the magnetic layer of the master carrier is very thin; i.e., has a thickness of about several tens of nanometers, and is very susceptible to a demagnetizing field. Therefore, even when the magnetic layer is made of a magnetic material having high saturation magnetization, the magnetic field (recording magnetic field) effectively applied to the magnetic layer is weakened due to the demagnetizing field, resulting in that the magnetic layer becomes undesirably in an unsaturated state As a result, the magnetization of the magnetic layer cannot be increased as expected, which is problematic.

In view of this, attempts have been made to use, as a material for the magnetic layer, a magnetic material having perpendicular magnetic anisotropy which is not easily affected by a demagnetizing field.

Although a magnetic layer made of a magnetic material having perpendicular magnetic anisotropy is not easily affected by a demagnetizing field, the magnetic layer problematically has a high coercive force Hc and a high residual magnetization Mr.

When the coercive force Hc is high, the magnetic layer requires an increased magnetic filed for saturation. The increased magnetic field magnetizes other portions than the magnetic layer in the master carrier. Thus, a magnetic field in the other portions may problematically magnetize the perpendicular magnetic recording medium.

When the residual magnetization Mr is high, the perpendicular magnetic recording medium may be unnecessarily magnetized by the residual magnetization of the magnetic layer of the master carrier, upon being separated from the master carrier as described above. This phenomenon occurs even when the master carrier very slightly slides against the perpendicular magnetic recording medium in an in-plane direction.

### BRIEF SUMMARY OF THE INVENTION

The present invention aim to solve the above-described problems pertinent in the art and to achieve the following objects. That is, an object of the present invention is to provide a magnetic transfer master carrier having a magnetic layer which has perpendicular magnetic anisotropy and is decreased in coercive force and residual magnetization; a magnetic transfer method employing the magnetic transfer master carrier; and a magnetic recording medium produced using the magnetic transfer master carrier.

The present inventors conducted extensive studies in view of the above, and have obtained the finding; i.e., when a magnetic layer is formed not only the top surfaces of convex portions of a magnetic transfer master carrier but also the side surfaces thereof, the magnetic layer is decreased in coercive force and residual magnetization.

Also, the present inventors have found that when the ratio w2/w1 is 0.2 to 0.8, where w1 denotes a thickness of the magnetic layer on the top surfaces of the convex portions, and w2 denotes a thickness of the magnetic layer of the side surfaces of the convex portions, the magnetic layer is remarkably decreased in coercive force and residual magnetization.

Further, the present inventors have found that when a soft magnetic layer is formed on a magnetic layer on at least the top surfaces of the convex portions, the magnetic layer is decreased in coercive force and residual magnetization.

The present invention is accomplished on the basis of the above findings obtained by the present inventors, and the means for solving the above existing problems are as follows.

<1> A magnetic transfer master carrier including:

a base material having, in its surface, convex portions arranged correspondingly to a pattern of information to be recorded on a perpendicular magnetic recording medium, and

a magnetic layer having perpendicular magnetic anisotropy, the layer being provided on top and side surfaces of the convex portions,

wherein the magnetic transfer master carrier forms a magnetic field pattern corresponding to the pattern of the information when a magnetic field is applied thereto.

The magnetic transfer master carrier described in <1> above is decreased in coercive force and residual residual magnetization, since a magnetic layer is formed both top and side surfaces of the convex portions.

<2> The magnetic transfer master carrier according to <1> above, wherein a ratio w2/w1 is 0.2 to 0.8, where w1 denotes a thickness of the magnetic layer formed on the top surfaces of the convex portions, and w2 denotes a thickness of the magnetic layer formed on the side surfaces of the convex portions.

<3> The magnetic transfer master carrier according to any one of <1> and <2> above, further comprising a soft magnetic layer on at least the magnetic layer formed on the top surfaces of the convex portions.

<4> A magnetic transfer method including:

initially magnetizing a perpendicular magnetic recording medium by applying a magnetic field thereto,

closely attaching the magnetic transfer master carrier according to any one of <1> to <3> above to the initially magnetized perpendicular magnetic recording medium, and

magnetically transferring information to the perpendicular magnetic recording medium by applying thereto a magnetic field whose direction is opposite to a direction of the magnetic field applied in the initial magnetization, with the perpendicular magnetic recording medium and the magnetic transfer master carrier being closely attached to each other, so that the information is recorded on the perpendicular magnetic recording medium.

<5> A magnetic recording medium obtained by the magnetic transfer method according to <4> above.

The present invention can provide a magnetic transfer master carrier having a magnetic layer which has perpendicular magnetic anisotropy and is decreased in coercive force and residual magnetization; a magnetic transfer method employing the magnetic transfer master carrier; and a magnetic recording medium produced using the magnetic transfer master carrier. These can solve the above-described existing problems.

### BRIEF DESCRIPTION OF THE DRAWINGS

FIG. 1A is a schematic view of a first step of a magnetic transfer method.

FIG. 1B is a schematic view of a second step of a magnetic transfer method.

FIG. 1C is a schematic view of a third step of a magnetic transfer method.

FIG. 2 is a schematic cross-sectional view of a magnetic transfer master carrier.

FIG. 3 is a partially enlarged view of the magnetic transfer master carrier shown in FIG. 2.

FIG. 4 is a top view of a magnetic transfer master carrier.

FIG. 5 is a schematic explanatory view of a base material in another embodiment.

FIG. 6 is a schematic explanatory view of a base material in another embodiment.

FIG. 7 is a schematic explanatory view of a magnetic transfer master carrier in another embodiment.

FIG. 8A is a first explanatory top view of a magnetic layer on a convex portion.

FIG. 8B is a second explanatory top view of a magnetic layer on a convex portion.

FIG. 9 schematically shows M-H curves of magnetic layers.

FIG. 10A is an explanatory view of a first production step for an original master used for producing a magnetic transfer master carrier.

FIG. 10B is an explanatory view of a second production step for an original master used for producing a magnetic transfer master carrier.

FIG. 10C is an explanatory view of a third production step for an original master used for producing a magnetic transfer master carrier.

FIG. 10D is an explanatory view of a fourth production step for an original master used for producing a magnetic transfer master carrier.

FIG. 10E is an explanatory view of a fifth production step for an original master used for producing a magnetic transfer master carrier.

FIG. 10F is an explanatory view of a sixth production step for an original master used for producing a magnetic transfer master carrier.

FIG. 11G is an explanatory view of a first production step for a magnetic transfer master carrier.

FIG. 11H is an explanatory view of a second production step for a magnetic transfer master carrier.

FIG. 11I is an explanatory view of a third production step for a magnetic transfer master carrier.

FIG. 11J is an explanatory view of a fourth production step for a magnetic transfer master carrier.

FIG. 11K is an explanatory view of a fifth production step for a magnetic transfer master carrier.

FIG. 12 is a schematic cross-sectional view of a perpendicular magnetic recording medium.

FIG. 13 shows the magnetization direction of a magnetic layer of a perpendicular magnetic recording medium having undergone initial magnetization.

FIG. 14 is a cross-sectional view of a perpendicular magnetic recording medium and a magnetic transfer master carrier during magnetic transfer.

FIG. 15 shows the magnetization direction of a magnetic layer of a perpendicular magnetic recording medium having undergone magnetic transfer.

FIG. 16 is a schematic view of a magnetic transfer apparatus.

FIG. 17A shows a general M-H curve of a perpendicularly magnetized film.

FIG. 17B shows another M-H curve of a perpendicularly magnetized film.

### DETAILED DESCRIPTION OF THE INVENTION

With reference to the drawings, next will be described a magnetic transfer master carrier, a magnetic transfer method and a magnetic recording medium according to one embodiment of the present invention.

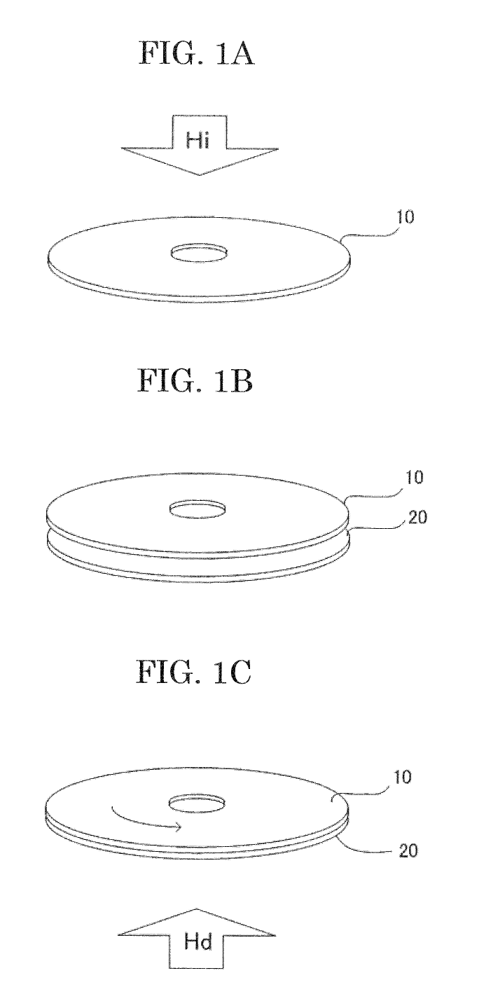

FIGS. 1A to 1C roughly illustrate a magnetic transfer method in which information is magnetically transferred to a perpendicular magnetic recording medium using a magnetic transfer master carrier. The magnetic transfer method includes an initial magnetization step, a closely attaching step and a magnetic transfer step. Referring to FIGS. 1A to 1C, first will be roughly described a magnetic transfer technique using the magnetic transfer master carrier.

### [Rough Description of Magnetic Transfer Technique]

In FIGS. 1A to 1C, reference numerals 10 and 20 denote a perpendicular magnetic recording medium (i.e., a slave disc) and a magnetic transfer master carrier (i.e., a master disc), respectively.

FIG. 1A illustrates an initial magnetization step. As shown in FIG. 1A, in the initial magnetization step, a DC magnetic field (Hi) is applied to a slave disc 10 to initially magnetize the slave disc 10. The DC magnetic field (Hi) is applied to the surface of the slave disc 10 in a perpendicular direction thereto.

FIG. 1B illustrates a closely attaching step. As shown in FIG. 1B, in the closely attaching step, the master disc 20 is closely attached to the initially magnetized slave disc 10.

FIG. 1C illustrates a magnetic transfer step. As shown in FIG. 1C, in the magnetic transfer step, a magnetic field (Hd) (recording magnetic field), whose direction is opposite to that of the DC magnetic field (Hi), is applied to the slave disc 10 and the master disc 20 that have been attached to each other, to thereby record on the slave disc 10 information corresponding to the master disc 20.

Next will be described the magnetic transfer master carrier, the magnetic transfer method and the magnetic recording medium with reference to the corresponding drawings.

### [Magnetic Transfer Master Carrier]

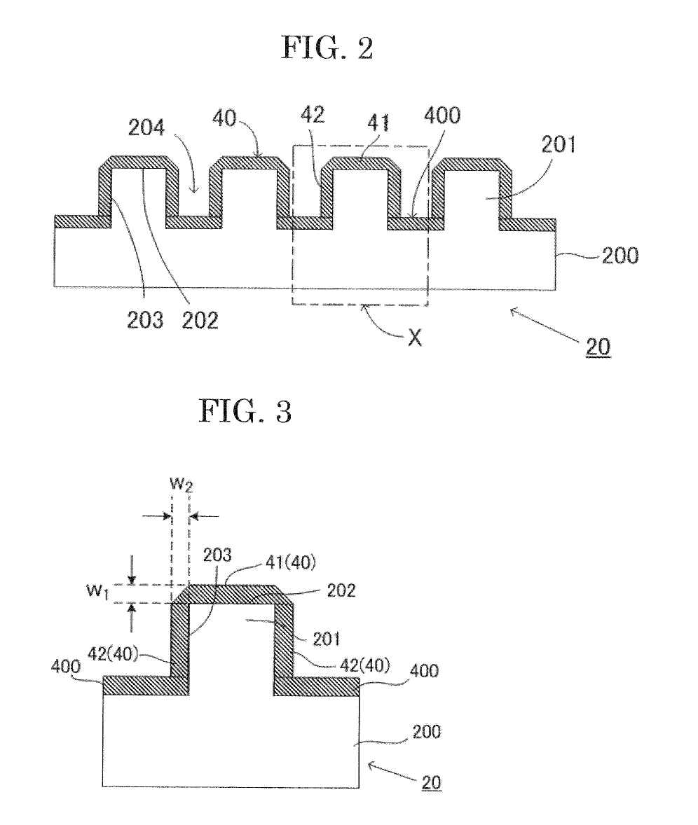

FIG. 2 is a cross-sectional view of the magnetic transfer master carrier (master disc) 20. FIG. 3 is partially enlarged view of part of the magnetic transfer master carrier 20 shown in FIG. 2, wherein a part X enclosed by a dot-dash line is enlarged. As shown in FIGS. 2 and 3, the magnetic transfer master carrier 20 includes a base material 200 and a magnetic layer 40.

### (Base Material)

The material for the base material 200 is not particularly limited and may be appropriately selected depending on the purpose. Examples thereof include known materials such as glass, synthetic resins (e.g., polycarbonates), metals (e.g., nickel and aluminum), silicon and carbon.

The shape of the base material 200 is not particularly limited and may be appropriately selected depending on the purpose. The magnetic transfer master carrier 20 shown in FIG. 2 has a disc shape. The base material 200 has a plurality of convex portions 201.

The convex portions 201 are arranged in the base material 200 correspondingly to the pattern of information to be recorded on the perpendicular magnetic recording medium. Examples of the information to be recorded on the perpendicular magnetic recording medium include servo information used for tracking servo (e.g., servo signals and address information signals). The convex portions 201 form, in the base material 200, a pattern corresponding to the pattern of information to be recorded. The number of the convex portions 201 arranged in the base material 200 is not particularly limited and may be appropriately determined depending on the purpose.

FIG. 4 is a top view of the magnetic transfer master carrier 20 (master disc). As shown in FIG. 4, a pattern (servo pattern 52), which is formed by arranging convex portions correspondingly to the pattern of servo information, is radially formed in the surface (top surface) of the magnetic transfer master carrier 20.

As shown in FIGS. 2 and 3, the surface of each convex portion 201 has a top surface 202 and a side surface 203. In the present embodiment, the top surface 202 is a flat surface. The shape of the top surface 202 is not particularly limited and may be appropriately determined depending on the purpose. In the present embodiment, the top surface 202 has a quadrangular (square) shape. Concave portions 204 are formed between the convex portions 201.

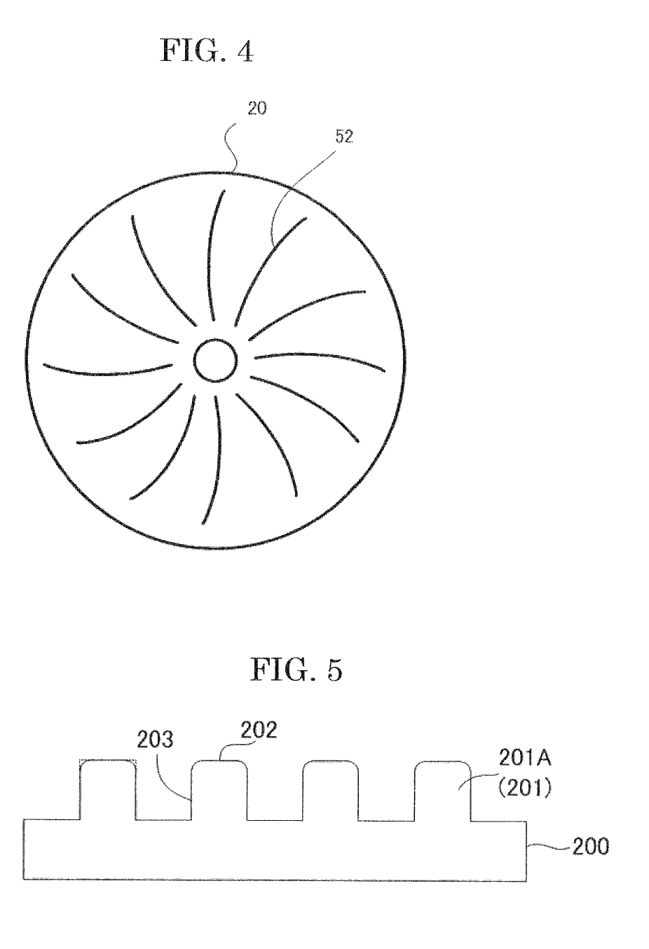

FIG. 5 is an explanatory view of a base material 200 according to another embodiment. As shown in FIG. 5, convex portions 201 (201A) may be cut off their edges. This edge cutting may be carried out by known methods such as ashing. The cut edges of the convex portions 201 (201A) are rounded. When each convex portion has round cut edges, a magnetic film grown on the top surface 202 and a magnetic film grown on the side surface 203 are easier to form a single magnetic film without discontinuity.

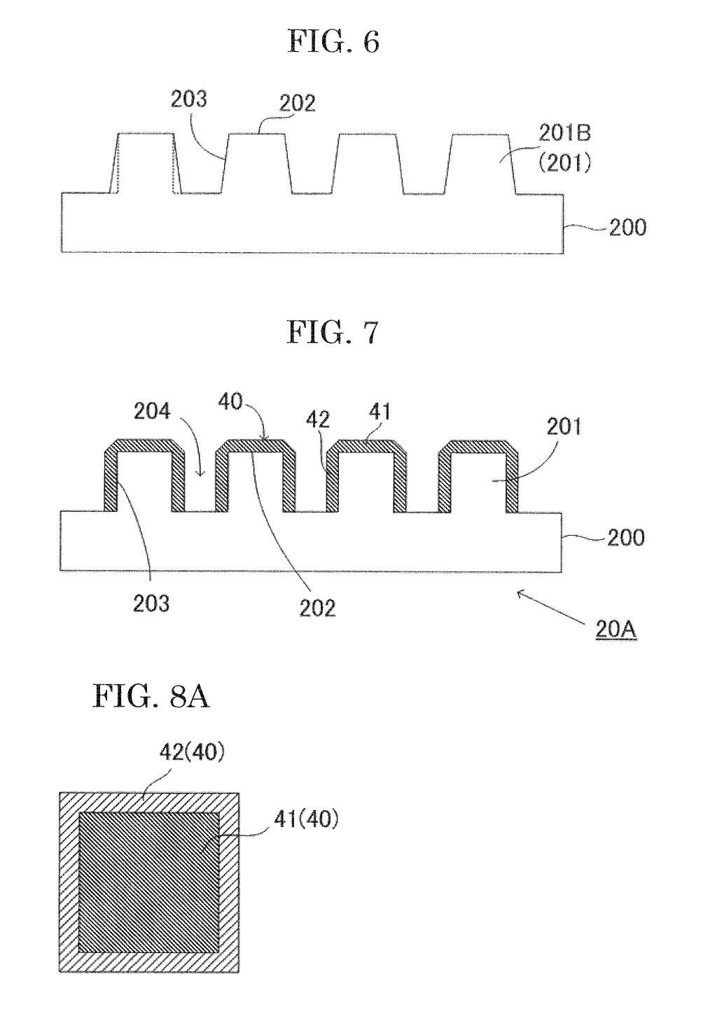

FIG. 6 is an explanatory view of a base material 200 according to still another embodiment. As shown in FIG. 6, convex portions 201 (201B) may have such side surfaces 203 that are tapered toward to the top surfaces. When each convex portion has a tapered side surface 203, a magnetic layer 40 (42) is easier to be formed on the side surface 203, which is preferred.

### (Magnetic Layer)

The magnetic layer 40 is formed on the top surfaces 202 and the side surfaces 203 of the convex portions 201. Herein, the magnetic layer 40 on each top surface 202 may be referred to as a magnetic layer 41, and the magnetic layer 40 on each side surface 203 may be referred to as a magnetic layer 42.

In each convex portion, the magnetic layer 41 on the top surface 202 and the magnetic layers 42 on the side surfaces 203 form a single magnetic layer without discontinuity. The magnetic layers 42 are arranged so as to surround the magnetic layer 41.

In the present embodiment as shown in FIGS. 2 and 3, in order to, for example, allow easy production, the magnetic layer 40 is formed on each concave portion 204 in addition to the top surface 202 and the side surfaces 203 of the concave portion 201.

As shown in FIGS. 2 and 3, the magnetic layer 42 on each side surface 203 and the magnetic layer 40 on each concave portion 204 may form a single magnetic is layer without discontinuity. In this case, one end of the magnetic layer 42 on the side surface 203 is a contact point with the magnetic layer 40.

FIG. 7 roughly illustrates a magnetic transfer master carrier 20A according to another embodiment. In the magnetic transfer master carrier 20A shown in FIG. 7, a magnetic layer 40 (41 and 42) is formed only on a top surface 202 and a side surface 203 of each convex portion 201. Even when a magnetic layer 40 (41 and 42) is formed only on a top surface 202 and a side surface 203 of each convex portion 201 like the magnetic transfer master carrier 20A, the coercive force and the residual magnetization can be advantageously reduced in some degree. But, this effect is less than the case where a magnetic layer is formed on each concave portion 204 as shown in, for example, FIGS. 2 and 3.

The magnetic layer 40 contains a magnetic material having perpendicular magnetic anisotropy. The magnetic material for forming the magnetic layer 40 is alloys or compounds each being composed of at least one ferromagnetic metal of Fe, Co and Ni and at least one non-magnetic element of Cr, Pt, Ru, Pd, Si, Ti, B, Ta and O.

At least the magnetic layer 41 of the magnetic layer 40 has magnetic anisotropy in a perpendicular direction to the in-plane direction of the magnetic layer 41.

The thickness w1 of the magnetic layer 41 is not particularly limited and appropriately adjusted depending on the purpose. It is preferably 10 nm to 200 nm, more preferably 15 nm to 120 nm, still more preferably 20 nm to 80 nm.

When the thickness w1 of the magnetic layer 41 is smaller than 10 nm, the magnetic convex portions may not have a sufficient amount of magnetic flux to invert magnetization of a slave medium. Whereas when the thickness w1 is greater than 200 nm, each convex portion is deformed to degrade the quality of information transferred.

The thickness w2 of the magnetic layer 42 is not particularly limited and appropriately adjusted depending on the purpose. It is preferably 2 nm to 160 nm, more preferably 5 nm to 100 nm, still more preferably 6 nm to 60 nm.

When the thickness w2 of the magnetic layer 42 is smaller than 2 nm, the magnetic film 41 and the magnetic film 42 may not satisfactorily form a single magnetic film without discontinuity. Whereas when the thickness w2 is greater than 160 nm, the concave portions between the patterned magnetic convex portions are filled with the magnetic layer 42, potentially leading to degradation of the quality of information transferred.

The thickness w1 of the magnetic layer 41 can be measured with, for example, a stylus surface profile meter (DEKTAK6M, product of ULVAC).

The thickness w1 of the magnetic layer 41 is an average value (average thickness). The thickness w1 is calculated by averaging 12 values measured every 90° at each of 15 mm, 22 mm and 29 mm in radius.

When the thickness w1 of the magnetic layer 41 is small: less than 20 nm, a cross-sectional thin piece of the magnetic layer 41 is prepared through FIB processing, and is measured for thickness with a transmission electron microscope (TEM). In this case, the thickness w1 is calculated by averaging 4 values measured every 180° at each of 15 mm and 25 mm in radius.

The thickness w2 of the magnetic layer 42 is measured similar to the measurement in the case where the thickness w1 of the magnetic layer 41 is small. That is, a cross-sectional thin piece of the magnetic layer 42 is prepared through FIB processing, and is measured for thickness (w2) with a transmission electron microscope (TEM).

The ratio (w2/w1) of the thickness w2 of the magnetic layer 42 to the thickness w1 of the magnetic layer 41 is preferably 0.2 to 0.8.

The magnetic layer 40 is formed through, for example, sputtering. When sputtering is performed under the appropriately set conditions (e.g., film forming pressure (Pa), base material-target distance (mm) and DC power (W)), the magnetic layer 41 can be formed on the top surface 202 of the convex portion 201, and the magnetic layer 42 can be formed on the side surface 203 thereof.

Notably, when the base material-target distance is shortened and the number of particles that are sputtered straightforward is decreased, the magnetic layer 42 is easier to be formed on the side surface 203.

The magnetic layer 40 made of CoPt can be controlled in its perpendicular magnetic anisotropy by adjusting, among others, film forming pressure, Pt concentration and film forming temperature during formation thereof.

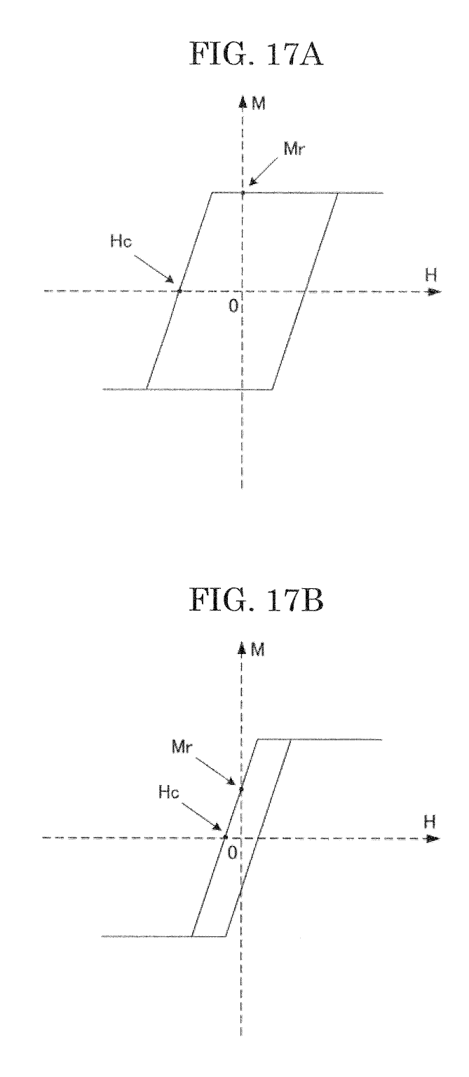

The coercive force Hc and residual magnetization Mr of the magnetic layer 40 are defined as follows. FIG. 17A shows a general M-H curve of a perpendicularly magnetized film. In this figure, the Hc is a negative intersection point between the curve and the horizontal axis H, and the Mr is a positive intersection point between the curve and the vertical axis M.

FIG. 17B shows another M-H curve of a perpendicularly magnetized film. Some perpendicularly magnetized films give such an M-H curve. The Hc and Mr are defined similar to the above.

The Hc and Mr are measured as follows

Specifically, an Ni film (thickness: 20 nm) is formed on an Si substrate (0.1016 m (4 inch)). The resultant substrate is provided thereon with the same layers as the magnetic layer and the underlying layer of a magnetic transfer master lo carrier under the same conditions as those under which the master carrier has been produced. The sample film formed on the Si substrate is cut into a piece having a size of 6 mm×8 mm. Using a vibrating sample magnetometer (VSM-C7, product of TOEI INDUSTRY CO., LTD), a magnetic field is applied to the obtained sample film in in-plane and perpendicular directions to give a magnetization curve thereof.

Based on the magnetization curve, the coercive force Hc and residual magnetization Mr of the sample film are calculated.

If necessary, the magnetic layer 40 may further include other layers such as a soft magnetic layer, an underlying layer and a protective layer.

Examples of the material for the soft magnetic layer include Fe, Fe alloy (e.g., FeCo and FeCoNi), Co, Co alloy (e.g., CoNi), Ni and Ni alloy (e.g., NiFe). Among them, FeCo and Co, which are high saturation magnetization materials, are particularly preferred. Notably, the soft magnetic layer is not particularly limited, so long as it is a soft or semi-hard magnetic layer having a low coercive force, and may be appropriately selected depending on the purpose.

The thickness of the soft magnetic layer is preferably 1 nm to 150 nm, more preferably 2 nm to 90 nm. The soft magnetic layer having a too small thickness: less than 1 nm cannot effectively decrease the Hc and Mr. In contrast, when the thickness is a too great: more than 150 nm, the perpendicularly magnetized film of the convex portion is distant from a slave disc, potentially leading to degradation of recording performance.

The soft magnetic layer is formed through, for example, sputtering, vacuum film formation (e.g., vacuum vapor deposition and ion plating) and plating.

### (Underlying Layer)

If necessary, an underlying layer may be formed under the magnetic layer 40.

Examples of the material for the underlying layer include Pt, Ru, Pd, Co, Cr, Ni, W, Ta, Al, P, Si, Ti, and alloys or compounds each containing at least one of the above-listed metals, with platinum group metals (e.g., Pt and Ru) and alloys containing them being preferred. The underlying layer may have a single- or multi-layer structure. The underlying layer can be formed with a known method such as sputtering.

The thickness of the underlying layer is preferably 1 nm to 30 nm, more preferably 3 nm to 10 nm.

### (Protective Layer and Others)

If necessary, a protective layer may be formed on the magnetic layer 40 from, for example, diamond-like carbon. The thickness of the protective layer is generally 10 nm or less. Furthermore, a lubricating layer may be formed on the protective layer.

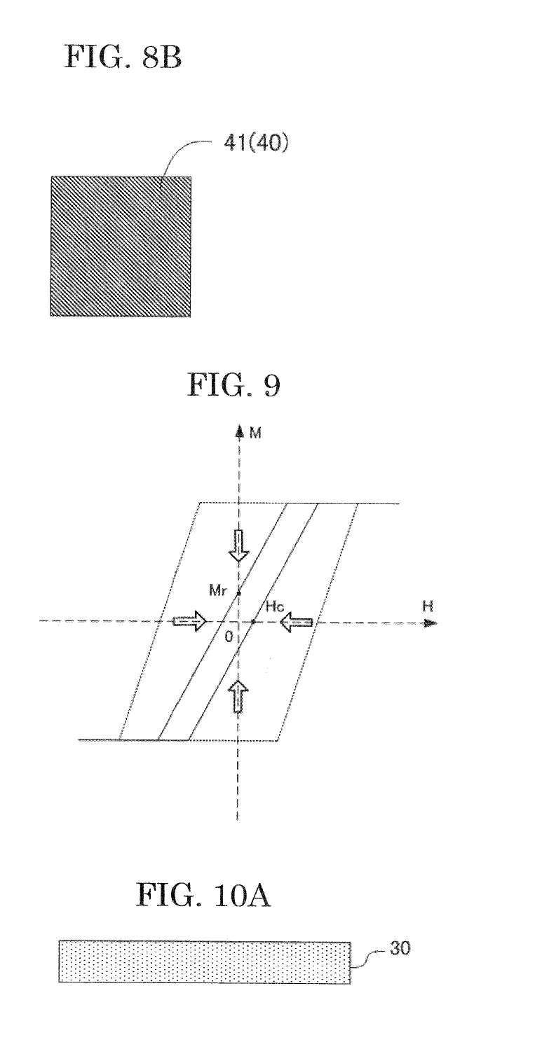

With reference to FIGS. 8A, 8B and 9, next will be described the magnetic characteristics of the magnetic layer 40 of the magnetic transfer master carrier 20 of the present invention. FIG. 8A is an explanatory top view of the magnetic layer 40 on the convex portion. As shown in FIG. 8A, the magnetic layer 41 on the convex portion is surrounded by the magnetic layer 42 on the side surface.

FIG. 8B is an explanatory top view of a conventional convex portion, wherein the magnetic layer 41 is formed only on the top surface thereof.

FIG. 9 schematically shows M-H curves of the magnetic layers shown in FIGS. 8A and 8B. In FIG. 9, the horizontal axis corresponds to a magnetic field (H), and the vertical axis corresponds to the intensity of magnetization (M). In FIG. 9, a solid line corresponds to the M-H curve of the magnetic layer 40 in the present invention as shown in FIG. 8A, and a dashed line corresponds to the M-H curve of the magnetic layer 41 of a conventional type as shown in FIG. 8B.

As shown in FIG. 9, the coercive force Hc of the magnetic layer 40 in the present invention is lower than that of the magnetic layer 41 formed only on the top surface like conventional cases, since the magnetic layer 40 has the magnetic layer 41 and the magnetic layer 42 surrounding it. Also, the residual magnetization Mr of the magnetic layer 40 is lower than that of the magnetic layer 41 formed only on the top surface like conventional cases.

The reason for this is supposedly as follows. Specifically, the magnetic layer 40, which comes to have a single magnetic domain in accordance with downsizing thereof, forms a single magnetic layer together with the magnetic layer 42 on the side surface so as to have a multi magnetic domain, and magnetization is performed through domain wall displacement rather than magnetization rotation.

As described above, the magnetic layer 40 of the magnetic transfer master carrier 20 of the present invention has the magnetic layer 42 surrounding the magnetic layer 41 on the top surface and thus, the magnetic layer 40 can be decreased in coercive force Hc and residual magnetization Mr.

### [Production Method for Magnetic Transfer Master Carrier]

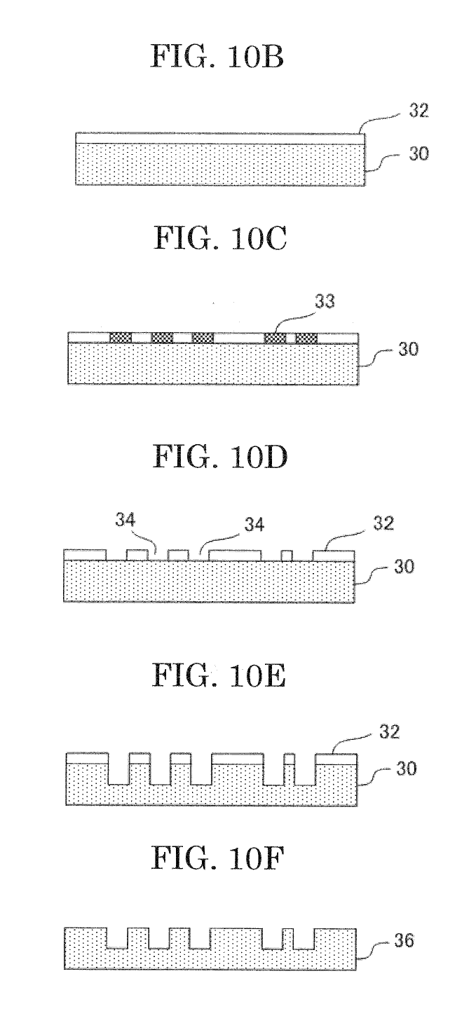

The magnetic transfer master carrier 20 is produced using an original master. First, one production method for the original master is described as follows with reference to FIGS. 10A to 10F.

### (Production of Original Master)

FIGS. 10A to 10F illustrate steps of producing an original master used for producing the magnetic transfer master carrier 20.

As shown in FIG. 10A, an original plate 30—a silicon wafer having a smooth surface (Si substrate)—is provided. Subsequently, an electron beam resist solution is applied onto the original plate 30 by, for example, spin coating so as to form a resist layer 32 thereon (see FIG. 10B). Thereafter, the resist film 32 is baked (pre-baked).

Next, the original plate 30 is set on a high-precision rotary stage or X-Y stage provided in an electron beam exposure apparatus (not shown). Then, an electron beam modulated correspondingly to a servo signal is applied to the resist layer 32 while the original plate 30 is being rotated, so that a pattern corresponding to a servo signal is formed in the resist layer 32 by writing exposure (see FIG. 10C). Notably, in FIG. 10C, reference numeral 33 denotes portions exposed.

Subsequently, as shown in FIG. 10D, the resist layer 32 is developed to remove exposed (written) portions 33, to thereby form a patterned resist layer 32 on the original plate 30.

Notably, the resist applied onto the original plate 30 may be of positive type or negative type. Here, an exposed (written) pattern formed using a positive-type resist is an inversion of an exposed (written) pattern formed using a negative-type resist.

After this development, baking (post-baking) is carried out to enhance adhesion between the resist layer 32 and the original plate 30.

Next, as shown in FIG. 10E, the original plate 30 is partially removed (etched) from opening portions 34 of the resist layer 32 serving as a mask, such that hollows having a predetermined depth are formed in the original plate. As to this etching, anisotropic etching is preferable in that an undercut (side etching) can be minimized. As such anisotropic etching, reactive ion etching (RIE) may be suitably employed.

Thereafter, as shown in FIG. 10F, the resist layer 32 is removed after etching. Regarding the method for removing the resist layer 32, for example, ashing can be employed as a dry method, and a removal method using a release solution can be employed as a wet method. After removal of the resist layer 32, an original master 36 is obtained.

### (Production of Magnetic Transfer Master Carrier)

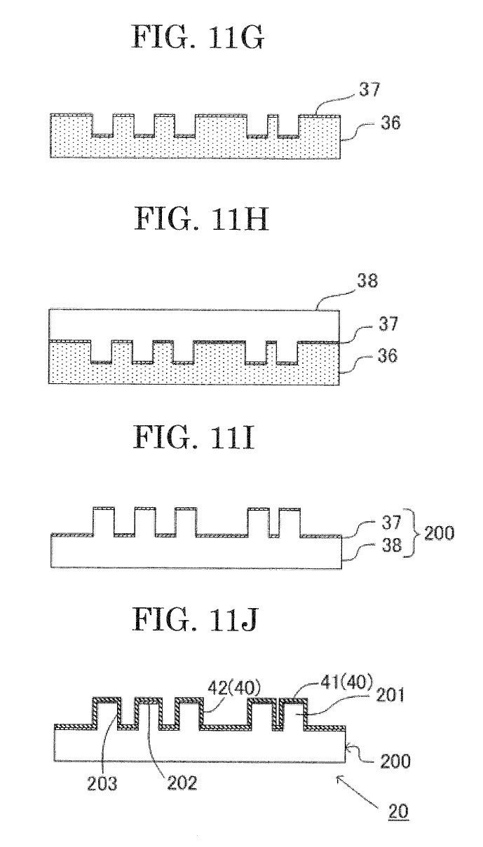

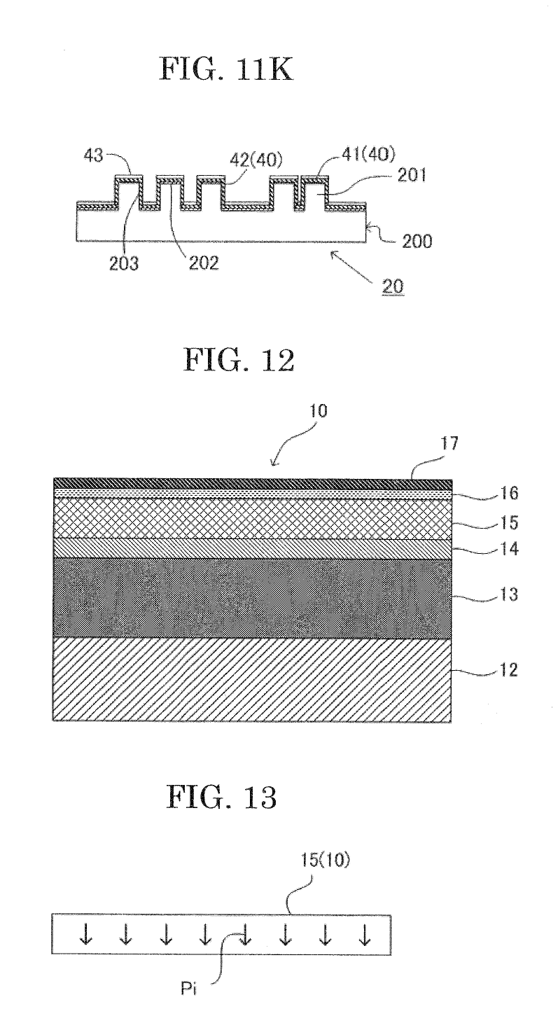

With reference to FIGS. 11G to 11K, next will be described one production method for a magnetic transfer master carrier 20 which method uses the original master 36.

As shown in FIG. 11G, the surface of the original master 36 is provided with a conductive layer 37 having a uniform thickness. The method for forming the conductive layer 37 can be selected from a variety of metal deposition methods such as physical vapor deposition (PVD) and chemical vapor deposition (CVD). For example, the conductive layer 37 is a film made mainly of Ni. Since such a film can be easily formed and is hard, it is suitable for the conductive film 37. The thickness of the conductive layer 37 is not particularly limited and may be appropriately determined depending on the purpose. In general, it is about several tens of nanometers.

Next, as shown in FIG. 11H, a metal plate 38 having a desired thickness is formed over the surface of the original master 36 through electrodeposition. Examples of the material for the metal plate include Ni.

Electrodeposition is carried out in a predetermined electrodepositing device (not shown). The electrodepositing device includes an electrolytic bath containing an electrolytic solution such as a nickel sulfamate solution, and the original master 36 is immersed in the electrolytic solution placed in the electrolytic bath. When an electric current is applied between an unillustrated cathode and the original master 36 serving as an anode, a metal plate is formed on the original plate 36 through deposition. Notably, the conditions such as the concentration or pH of the electrolytic solution and the electric current value used are appropriately set.

The original master 36 over which a metal plate 38 has been laid in the above manner is taken out from the electrolytic solution placed in the electrodepositing device, and then immersed in releasing liquid containing, for example, purified water. In the releasing liquid, the metal plate 38 is separated from the original master 36. In this manner, there is produced a base material 200 as shown in FIG. 11I which has a concavo-convex pattern inverted with respect to the pattern of the original master 36.

Next, as shown in FIG. 11J, magnetic layers 40 (41 and 42) are formed on the top surfaces 202 and the side surfaces 203 of convex portions 201 of the base material 200.

Examples of the material for the magnetic layer 40 include CoPt. The magnetic layer 40 is formed through sputtering using a material selected as a target.

If necessary, the base material 200 is, for example, punched out so as to have a predetermined size to produce a magnetic transfer master carrier 20.

Notably, as shown in FIG. 11K, a soft magnetic layer 43 may be formed on the magnetic layer 40 in accordance with needs.

Examples of the material for the soft magnetic layer 43 include FeCo and Co. The soft magnetic layer 43 is formed through sputtering using a material selected as a target.

### [Perpendicular Magnetic Recording Medium]

A perpendicular magnetic recording medium to which information is magnetically transferred using the magnetic transfer master carrier 20 is not particularly limited and may be appropriately selected depending on the purpose. FIG. 12 is a schematic cross-sectional view of a perpendicular magnetic recording medium. With reference to FIG. 12, next will be described the layer structure of a perpendicular magnetic recording medium in one embodiment.

As shown in FIG. 12, the perpendicular magnetic recording medium 10 includes a substrate 12, a soft magnetic layer (soft magnetic underlying layer: SUL) 13, a non-magnetic layer (intermediate layer) 14 and a magnetic layer 15. The perpendicular magnetic recording medium 10 shown in FIG. 12 further includes a protective layer 16 and a lubricating layer 17 on the magnetic layer 15.

The substrate 12 has a disc shape and is made of a non-magnetic material such as glass or aluminum (Al).

The soft magnetic layer 13 is provided for the purposes of, for example, stabilizing the perpendicular magnetization in the magnetic layer 15 and enhancing sensitivity during recording/reproducing. The soft magnetic layer 13 is made of a soft magnetic material such as CoZrNb, FeTaC, FeZrN, FeSi alloy, FeAl alloy, FeNi alloy (e.g., permalloy) and FeCo alloy (e.g., permendur). The soft magnetic layer 13 is treated so as to have magnetic anisotropy oriented in a radial direction of a disc (in a radial fashion) (i.e., from the center to the periphery).

The non-magnetic layer 14 is provided for the purposes of, for example, increasing the magnetic anisotropy of the magnetic layer 15 to be formed thereon. The non-magnetic layer 14 is preferably made, for example, of Ti, Cr, CrTi, CoCr, CrTa, CrMo, NiAl, Ru, Pd, Ta or Pt.

The magnetic layer 15 is a perpendicularly magnetized film. In the perpendicularly magnetized film, most of the axes of easy magnetization are arranged mainly perpendicularly to the substrate 12. Information is recorded on the magnetic layer 15.

The magnetic layer 15 is made, for example, of Co alloy (e.g., CoPtCr, CoCr, CoPtCrTa, CoPtCrNbTa, CoCrB or CoPt), Co alloy-SiO₂, Co alloy-TiO₂ or Fe alloy (e.g., FePt).

The protective layer 16 is made, for example, of carbon (C), and the lubricating layer 17 is made, for example, of a fluorine-based lubricant such as PFPE.

Notably, in the perpendicular magnetic recording medium 10, the magnetic layer 15 is formed on one surface of the substrate 12. Alternatively, in another embodiment, both surfaces of the substrate 12 may be provided with the magnetic layers 15.

Also, in another embodiment, two or more soft magnetic layers 13 and/or two or more non-magnetic layers 14 may be provided.

### [Magnetic Transfer Method]

Next will be described a method in which information is magnetically transferred to the above-described perpendicular magnetic recording medium using the above-described magnetic transfer master carrier.

As described in the above [Rough description of magnetic transfer technique], the magnetic transfer method includes an initial magnetization step, a closely attaching step and a magnetic transfer step. With reference to FIG. 1 and other figures, next will be described a magnetic transfer method according to one embodiment.

### <Initial Magnetization Step>

The initial magnetization step is a step of initially magnetizing the perpendicular magnetic recording medium 10 (slave disc) by applying a DC magnetic field (Hi) to the perpendicular magnetic recording medium 10.

As shown in FIG. 1(a), in the initial magnetization step, a DC magnetic field (Hi) is applied to the perpendicular magnetic recording medium 10. The DC magnetic field (initial magnetic field) (Hi) is applied to the surface of the perpendicular magnetic recording medium 10 in a perpendicular direction thereto. The DC magnetic field (Hi) is applied with a predetermined magnetic field application unit (not illustrated). The intensity of the DC magnetic field (Hi) is set to be equal to or higher than the coercive force Hc of the perpendicular magnetic recording medium 10.

FIG. 13 illustrates the magnetization direction of the magnetic layer of the initially magnetized perpendicular magnetic recording medium. As shown in FIG. 13, the magnetic layer 15 of the initially magnetized perpendicular magnetic recording medium 10 is unidirectionally magnetized in a perpendicular direction to the disc surface of the perpendicular magnetic recording medium 10. Notably, in FIG. 13, an arrow denoted by reference character Pi indicates the magnetization direction of the magnetic layer.

### <Closely Attaching Step>

The closely attaching step is a step of closely attaching a magnetic transfer master carrier (master disc) 20 to the initially magnetized perpendicular magnetic recording medium 10. As shown in FIG. 1(b), the initially magnetized perpendicular magnetic recording medium 10 and the magnetic transfer master carrier 20 are superposed with and closely attached to each other.

In the closely attaching step, the magnetic layer 40 on the convex portions 201 of the magnetic transfer master carrier 20 is closely attached to the magnetic layer (recording layer) of the perpendicular magnetic recording medium 10. The magnetic transfer master carrier 20 is closely attached to the perpendicular magnetic recording medium 10 using a predetermined pressing force.

If necessary, before closely attached to the magnetic transfer master carrier 20, the perpendicular magnetic recording medium 10 is subjected to a cleaning process (e.g., burnishing) in which minute protrusions or attached powdery dust on its surface is removed using, for example, a grind head or a polisher.

In the closely attaching step in the present embodiment, as shown in FIG. 1(b), the magnetic transfer master carrier 20 is closely attached only to one surface of the perpendicular magnetic recording medium 10. In another embodiment, magnetic transfer master carriers 20 may be closely attached to magnetic layers formed on both surfaces of the perpendicular magnetic recording medium (slave disc).

### <Magnetic Transfer Step>

The magnetic transfer step is a step of recording, on the perpendicular magnetic recording medium 10, information corresponding to the magnetic transfer master carrier 20 by applying a recording magnetic field (Hd) whose direction is opposite to that of the initially magnetizing magnetic field (Hi) to the perpendicular magnetic recording medium 10 and the magnetic transfer master carrier 20 that have been closely attached to each other.

As shown in FIG. 1(c), using a predetermined magnetic field application unit (not illustrated), a recording magnetic field (Hd) whose direction is opposite to that of the initially magnetizing magnetic field (Hi) is applied to the perpendicular magnetic recording medium 10 and the magnetic transfer master carrier 20 that have been closely attached to each other.

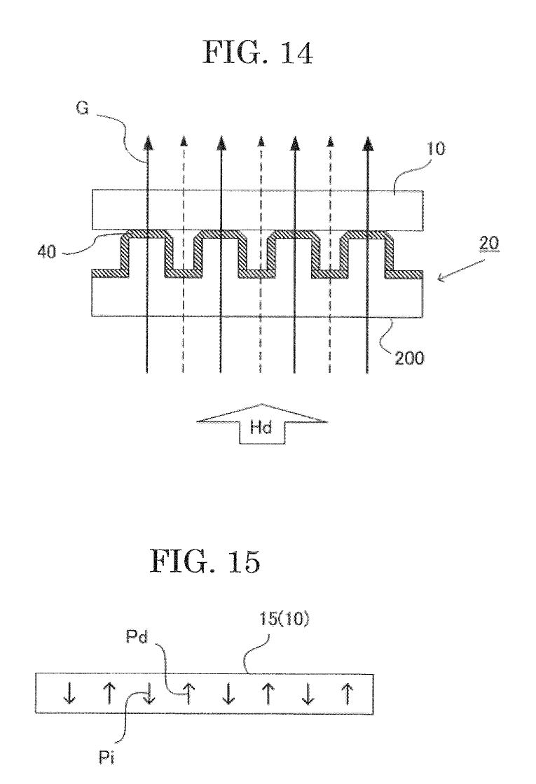

FIG. 14 is a cross-sectional view of the perpendicular magnetic recording medium 10 and the magnetic transfer master carrier 20 in the magnetic transfer step. As shown in FIG. 14, when the recording magnetic field (Hd) is applied with the perpendicular magnetic recording medium 10 being closely attached to the magnetic transfer master carrier 20, a magnetic flux G generated from the magnetic field (Hd) enters the magnetic transfer master carrier 20 and then is absorbed in a magnetic layer 40 of the magnetic transfer master carrier 20. As a result, a magnetic field becomes strong at the convex portions 201 of the magnetic transfer master carrier 20. In contrast, at the concave portions 204 of the magnetic transfer master carrier 20, a magnetic field is weaker than at the convex portions 201. In this manner, a magnetic field pattern is formed which corresponds to information to be recorded on the perpendicular magnetic recording medium 10.

As a result, in the perpendicular magnetic recording medium 10, the magnetization direction of portions of the magnetic layer 15 that correspond to the convex portions 201 is inverted to record information. Notably, the magnetization direction of portions of the magnetic layer 15 that correspond to the concave portions 204 remains unchanged.

FIG. 15 is an explanatory cross-sectional view of a magnetic layer of a perpendicular magnetic recording medium having undergone a magnetic transfer step, wherein the direction in which the magnetic layer is magnetized is shown. As shown in FIG. 15, on the magnetic layer 15 of the perpendicular magnetic recording medium 10, information such as a servo signal is recorded as a recording magnetization Pd which is in the opposite direction to the initial magnetization Pi.

The intensity of the recording magnetic field (Hd) may be appropriately determined depending on the purpose. In general, it is preferably 40% to 130% of the coercive force (Hc) of the magnetic layer 16 of the perpendicular magnetic recording medium 10, more preferably 50% to 120% thereof.

When information is recorded (magnetically transferred) on the perpendicular magnetic recording medium 10 using the magnetic transfer master carrier 20, for example, the recording magnetic field (Hd) may be applied by the magnetic field application unit while the perpendicular magnetic recording medium 10 and the magnetic transfer master carrier 20 that have been closely attached to each other is being rotated by a predetermined rotating unit (not illustrated). In another embodiment, a mechanism of rotating the magnetic field application unit may be provided such that the magnetic field application unit is rotated relatively to the perpendicular magnetic recording medium 10 and the magnetic transfer master carrier 20.

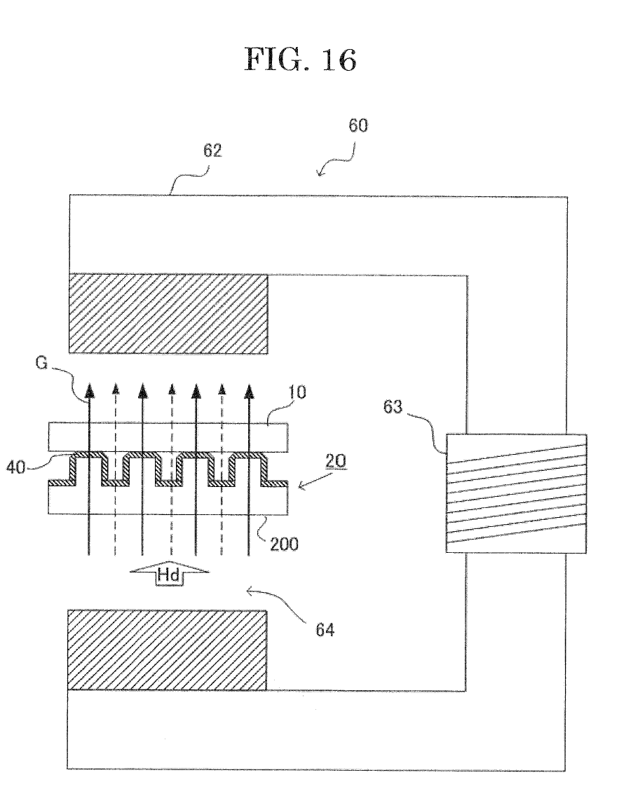

FIG. 16 schematically illustrates a magnetic transfer apparatus. The magnetic transfer apparatus includes a magnetic field application unit 60 composed of an electromagnet which is formed by winding a coil 63 around a core 62. The magnetic transfer apparatus is configured such that, when an electric current is applied to the coil 63, a magnetic field is generated in a gap 64 perpendicularly to the magnetic transfer master disk 20 and the perpendicular magnetic recording medium 10 that have been closely attached to each other. The direction of the magnetic field generated can be changed by changing that of the electric current applied to the coil 63. This magnetic transfer apparatus, therefore, makes it possible to initially magnetize the perpendicular magnetic recording medium 10 and also to carry out magnetic transfer.

A perpendicular magnetic recording medium on which information has been recorded using the magnetic transfer master carrier 20 is mounted in use to, for example, a magnetic recording/reproducing device such as hard disc devices, and provides a high recording density magnetic recording/reproducing device having high servo accuracy and preferred recording/reproducing characteristics.

### EXAMPLES

The present invention will next be described by way of examples, which should not be construed as limiting the present invention thereto.

### Example 1

### [Magnetic Transfer Master Carrier 1]

### (Production of Original Caster)

An electron-beam resist was applied onto an Si wafer (original plate) with a diameter of 0.2032 m (8 inch) through spin coating so as to have a thickness of 100 nm. Thereafter, the resist applied on the original plate was irradiated with an electron beam modulated correspondingly, for example, to a servo signal using a rotary electron beam exposure apparatus. Then, the resist was developed to remove unexposed portions, whereby the resist pattern of interest was formed on the original plate.

Subsequently, using the above-formed patterned resist as a mask, the original plate was subjected to a reactive etching treatment to etch portions with no resist (i.e., non-masked portions). The etching conditions were adjusted such that the acute angle formed between each bottom surface of the thus-formed concave portions and each side surface of the patterned convex portions was 78°. After this etching treatment, the resist remaining on the original plate was washed/removed with a solvent. Then, the original plate was dried to produce an original master used for producing a magnetic transfer master carrier.

### (Production of Magnetic Transfer Master Carrier)

A conductive layer (thickness: 10 nm) was formed on the original master out of Ni through sputtering. Using, as an original mold, the original master having the conductive layer, an Ni layer was formed on the original master through electrodeposition. Subsequently, the thus-formed Ni layer was separated from the original master, followed by washing, etc., to thereby produce an Ni base material having convex portions in its surface.

Next, the thus-produced Ni base material was set in a predetermined chamber, and the top and side surfaces of each convex portion of the Ni base material were provided through sputtering with Ta and Pt films serving as an underlying layer, and a CoPt film (Co₈₀Pt₂₀ at %) serving as a magnetic layer. The conditions for film formation are as follows.

### <Conditions for Film Formation>

### [Ta Film]

Film forming pressure: 2.0 Pa
Ni base material-target distance: 200 mm
DC power: 350 W
Film thickness: 10 nm

### [Pt Film]

Film forming pressure: 2.0 Pa
Ni base material-target distance: 200 mm
DC power: 400 W
Film thickness: 10 nm

### [CoPt Film]

Film forming pressure: 2.0 Pa
Ni base material-target distance: 200 mm
DC power: 1,000 W
Film thickness: 30 nm

### [Thickness of Magnetic Layer]

Thickness of magnetic layer on top surface w1=30 nm
Thickness of magnetic layer on side surface w2=12 nm

Through the above procedure, a magnetic transfer master carrier was produced.

### [Perpendicular Magnetic Recording Medium]

The below-described layers were formed in the following manner on a glass substrate with a diameter of 0.0635 m (2.5 inch) to produce a perpendicular magnetic recording medium.

Specifically, the produced perpendicular magnetic recording medium had, in sequence, a soft magnetic layer, a first non-magnetic orientation layer, a second non-magnetic orientation layer, a magnetic layer, a protective layer and a lubricating layer.

Notably, the soft magnetic layer, the first non-magnetic orientation layer, the second non-magnetic orientation layer, the magnetic layer and the protective layer were formed through sputtering, and the lubricating layer was formed by a dip method.

### (Formation of Soft Magnetic Layer)

The soft magnetic layer was made of CoZrNb so as to have a thickness of 100 nm.

Specifically, while an Ar gas was being fed into a chamber so that the gas pressure was adjusted to 0.6 Pa, the glass substrate was discharged at a DC power of 1,500 W with being placed so as to face a CoZrNb target.

### (Formation of First Non-Magnetic Orientation Layer)

The first non-magnetic orientation layer was made of Ti so as to have a thickness of 5 nm.

Specifically, while an Ar gas was being fed into a chamber so that the gas pressure was adjusted to 0.5 Pa, the glass substrate on which the soft magnetic layer had been formed was discharged at a DC power of 1,000 W with being placed so as to face a Ti target

### (Formation of Second Non-Magnetic Orientation Layer)

The second non-magnetic orientation layer was made of Ru so as to have a thickness of 6 nm.

Specifically, while an Ar gas was being fed into a chamber so that the gas pressure was adjusted to 0.8 Pa, the glass substrate over which the first non-magnetic orientation layer had been formed was discharged at a DC power of 900 W with being placed so as to face an Ru target.

### (Formation of Magnetic Layer)

The magnetic layer was made of CoCrPtO so as to have a thickness of 18 nm.

Specifically, while an Ar gas containing O₂ (0.06%) was being fed into a chamber so that the gas pressure was adjusted to 14 Pa, the glass substrate over which the second non-magnetic orientation layer had been formed was discharged at a DC power of 290 W with being placed so as to face a CoCrPtO target

### (Formation of Protective Layer)

The protective layer was made of C so as to have a thickness of 4 nm.

Specifically, while an Ar gas was being fed into a chamber so that the gas pressure was adjusted to 0.5 Pa, the glass substrate over which the magnetic layer had been formed was discharged at a DC power of 1,000 W with being placed so as to face a C target.

### (Formation of Lubricating Layer)

The lubricating layer was made of a PFPE lubricant so as to have a thickness of 2 nm.

The perpendicular magnetic recording medium was found to have a coercive force of 334 kA/m (4.2 kOe).

### [Magnetic Transfer]

### (Initial Magnetization Step)

The perpendicular magnetic recording medium was initially magnetized by applying a magnetic field thereto. The intensity of the magnetic field was adjusted to 10 kOe.

### (Closely Attaching Step)

The above-produced magnetic transfer master carrier was closely attached to the initially magnetized perpendicular magnetic recording medium at a pressure of 9 kg/cm².

### (Magnetic Transfer Step)

A recording magnetic field was applied to the perpendicular magnetic recording medium and the magnetic transfer master carrier that had been closely attached to each other. The intensity of the recording magnetic field was adjusted to 3.6 kOe.

Thereafter, application of the recording magnetic field was terminated and then, the magnetic transfer master carrier was separated from the perpendicular magnetic recording medium.

### [Evaluation 1]

### (Coercive Force Hc and Residual Magnetization Mr of Magnetic Transfer Master Carrier 1)

After termination of application of the recording magnetic field, the magnetic layer of the magnetic transfer master carrier 1, which had been separated from the perpendicular magnetic recording medium, was measured and evaluated for coercive force Hc and residual magnetization Mr.

The coercive force Hc and residual magnetization Mr were measured with a vibrating sample magnetometer (VSM-C7, product of TOEI INDUSTRY CO., LTD).

Notably, magnetic transfer master carriers are composed mainly of magnetic Ni materials, making it difficult to evaluate the magnetic characteristics of only the magnetic layer thereof. Thus, this evaluation was performed as follows. Specifically, an Si substrate having thereon a line-and-space pattern (L=0.5 μm and S=0.5 μm) was prepared as a substrate for evaluation. Then, a magnetic layer was formed on the substrate, and evaluated for magnetic characteristics.

The results are shown in Table 1.

### [Evaluation 2]

(Servo Signal Quality of Magnetic Recording Medium having Undergone Magnetic Transfer)

The perpendicular magnetic recording medium having undergone magnetic transfer was evaluated for qualities of recorded servo signals. In this evaluation, reproduction outputs (track average amplitude (TAA)) in a preamble area were detected in each sector positioned at a radius of 15 mm, and the SNR was calculated from the obtained values. This evaluation was carried out using LS-90 (product of Kyodo Denshi Co.) and a GMR head (read width: 120 nm and write width: 200 nm). The results are shown in Table 1.

### Example 2

### (Magnetic Transfer Master Carrier 2)

The procedure of Example 1 was repeated, except that an Si original plate and an Ni base material were formed so that the acute angle formed between each bottom surface of the concave portions and each side surface of the patterned convex portions was 74°, to thereby produce a magnetic transfer master carrier.

The thickness of the magnetic layer on the top surface w1 was found to be 30 nm, and the thickness of the magnetic layer on the side surface w2 was found to be 15 nm.

### Example 3

### (Magnetic Transfer Master Carrier 3)

The procedure of Example 1 was repeated, except that an Si original plate and an Ni base material were formed so that the acute angle formed between each bottom surface of the concave portions and each side surface of the patterned convex portions was 81°, to thereby produce a magnetic transfer master carrier.

The thickness of the magnetic layer on the top surface w1 was found to be 30 nm, and the thickness of the magnetic layer on the side surface w2 was found to be 9 nm.

### Example 4

### (Magnetic Transfer Master Carrier 4)

The procedure of Example 1 was repeated, except that a soft magnetic layer (43) was formed on the magnetic layer (40), to thereby produce a magnetic transfer master carrier.

The thickness of the magnetic layer on the top surface w1 was found to be 30 nm, the thickness of the magnetic layer on the side surface w2 was found to be 15 nm, and the thickness of the soft magnetic layer was found to be 5 nm.

### Referential Example 1

### (Magnetic Transfer Master Carrier 11)

The procedure of Example 1 was repeated, except that an Si original plate and an Ni base material were formed so that the acute angle formed between each bottom surface of the concave portions and each side surface of the patterned convex portions was 83°, to thereby produce a magnetic transfer master carrier.

The thickness of the magnetic layer on the top surface w1 was found to be 30 nm, and the thickness of the magnetic layer on the side surface w2 was found to be 5 nm.

TABLE 1

| | | Magnetic layer | | | | Evaluation | | |
|---|---|---|---|---|---|---|---|---|
| | Master | Top surface | Side surface | | Soft magnetic | | Mr | SNR |
| | carrier | w1 (nm) | w2 (nm) | w2/w1 | layer (nm) | Hc (Oe) | (emu/cc) | (dB) |
| Ex. 1 | 1 | 30 | 12 | 0.4 | Not provided | 1,530 | 248 | 13.7 |
| Ex. 2 | 2 | 30 | 15 | 0.5 | Not provided | 1,090 | 150 | 13.9 |
| Ex. 3 | 3 | 30 | 9 | 0.3 | Not provided | 2,670 | 494 | 13.1 |
| Ex. 4 | 4 | 30 | 15 | 0.5 | 5 | 860 | 112 | 14.6 |
| Ref. Ex. 1 | 11 | 30 | 5 | 0.17 | Not provided | 4,040 | 751 | 12.4 |

What is claimed is:

1. A magnetic transfer master carrier comprising:
a base material having, in its surface, convex portions arranged correspondingly to a pattern of information to be recorded on a perpendicular magnetic recording medium, and
a magnetic layer having perpendicular magnetic anisotropy, the layer being provided on top and side surfaces of the convex portions,
wherein the magnetic transfer master carrier forms a magnetic field pattern corresponding to the pattern of the information when a magnetic field is applied thereto.

2. The magnetic transfer master carrier according to claim 1, wherein a ratio w2/w1 is 0.2 to 0.8, where w1 denotes a thickness of the magnetic layer formed on the top surfaces of the convex portions, and w2 denotes a thickness of the magnetic layer formed on the side surfaces of the convex portions.

3. The magnetic transfer master carrier according to claim 1, further comprising a soft magnetic layer on at least the magnetic layer formed on the top surfaces of the convex portions.

4. A magnetic transfer method comprising
initially magnetizing a perpendicular magnetic recording medium by applying a magnetic field thereto,
closely attaching a magnetic transfer master carrier to the initially magnetized perpendicular magnetic recording medium, and
magnetically transferring information to the perpendicular magnetic recording medium by applying thereto a magnetic field whose direction is opposite to a direction of the magnetic field applied in the initial magnetization, with the perpendicular magnetic recording medium and the magnetic transfer master carrier being closely attached to each other, so that the information is recorded on the perpendicular magnetic recording medium,
wherein the magnetic transfer master carrier comprises a base material having, in its surface, convex portions arranged correspondingly to a pattern of information to be recorded on a perpendicular magnetic recording medium, and a magnetic layer having perpendicular magnetic anisotropy, the layer being provided on top and side surfaces of the convex portions; and the magnetic transfer master carrier forms a magnetic field pattern corresponding to the pattern of the information when a magnetic field is applied thereto.

5. A magnetic recording medium obtained by a magnetic transfer method comprising:
initially magnetizing a perpendicular magnetic recording medium by applying a magnetic field thereto,
closely attaching a magnetic transfer master carrier to the initially magnetized perpendicular magnetic recording medium, and
magnetically transferring information to the perpendicular magnetic recording medium by applying thereto a magnetic field whose direction is opposite to a direction of the magnetic field applied in the initial magnetization, with the perpendicular magnetic recording medium and the magnetic transfer master carrier being closely attached to each other, so that the information is recorded on the perpendicular magnetic recording medium,
wherein the magnetic transfer master carrier comprises a base material having, in its surface, convex portions arranged correspondingly to a pattern of information to be recorded on a perpendicular magnetic recording medium, and a magnetic layer having perpendicular magnetic anisotropy, the layer being provided on top and side surfaces of the convex portions; and the magnetic transfer master carrier forms a magnetic field pattern corresponding to the pattern of the information when a magnetic field is applied thereto.
